(19) United States
(12) Patent Application Publication
(10) Pub. No.: US 2018/0177308 A1
(43) Pub. Date: Jun. 28, 2018

(54) Illuminated Infant Diaper Changing System

(71) Applicant: Cory HEIMBUCH, Boise, ID (US)

(72) Inventor: Cory HEIMBUCH, Boise, ID (US)

(21) Appl. No.: 15/499,752

(22) Filed: Apr. 27, 2017

Related U.S. Application Data
(60) Provisional application No. 62/439,811, filed on Dec. 28, 2016.

(51) Int. Cl. A47D 5/00; F21S 9/02; F21V 23/04; F21V 31/00; F21V 23/06; H05B 33/08; F21V 23/00

(52) U.S. Cl. CPC A47D 5/00; F21S 9/02; F21V 23/0442; F21V 31/00; F21Y 2115/10; H05B 33/0845; H05B 33/0809; F21V 23/001; F21V 23/06

(57) ABSTRACT

An infant diaper changing system that includes embedded illumination configured to direct light to the diaper area of an infant, creating a well-lit work area and reducing light exposure to the infant's eyes and helping to prevent the infant from being woken by light. The system generally includes a changing pad for the infant to lie on, an illumination device configured to emit light toward or from a first predetermined area of the pad, and a mechanism configured to secure the illumination device directly or indirectly to the pad, or to direct the light to a second predetermined area of the pad different from the first predetermined area of the pad. In addition to optimum light location, varying degrees of material opacity and design work may further direct light towards the diaper area of the infant.

### CROSS-REFERENCE TO RELATED APPLICATIONS

This application claims the benefit of U.S. Provisional Patent Application No. 62/439,811, filed on Dec. 28, 2016, incorporated by reference herein as if fully set forth herein.

### FIELD OF THE INVENTION

The present invention generally relates to the field of infant diaper changing systems. More specifically, embodiments of the present invention pertain to a pad and/or a system for changing an infant and methods of changing a diaper of an infant and illuminating a diaper changing area of an infant.

### DISCUSSION OF THE BACKGROUND

In the past, cleaning or otherwise tending to a baby with a soiled diaper has been difficult in dark or sleep-time environments. Traditional overhead lighting sources may awaken or otherwise affect an infant's sleep pattern.

When a parent or caretaker wishes to clearly see an infant's bottom (referenced hereinafter as the “diaper area”) to clean waste or to inspect and treat rashes, parents have often resorted to higher than desirable overhead lighting, bright bedside lamps, or flashlights. These lights may be seen by the infant and may shine directly or indirectly into their eyes and irritate or wake up the infant. Existing diaper changing pads only provide a cushion and a contoured surface on which to set the infant.

Although some existing changing pads include entertainment lights for the baby or overhead lighting, none of the changing pads has integrated lighting under the baby, configured to limit the illumination to the diaper area of the infant. Accordingly, a demand exists for a changing pad having a light source configured to illuminate only the diaper area of an infant so as to help prevent the infant from being woken or otherwise disturbed.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Advantages of the present invention include the ability to change the diaper of an infant without disturbing the infant. The present invention avoids shining light into the infant's eyes that may wake or otherwise irritate the infant.

Thus, in one aspect, the present invention relates to an infant changing system. The infant changing system comprises a pad configured to support an infant during a diaper change, an illumination device configured to emit light toward or from a first predetermined area of the pad, and a mechanism configured to secure the illumination device directly or indirectly to the pad, or to direct the light to a second predetermined area of the pad different from the first predetermined area of the pad.

In some embodiments, the mechanism is configured to secure the illumination device directly or indirectly to the pad. In various embodiments, the mechanism comprises tape, hook and loop fasteners, snaps, clip harnesses, or metal prongs. In other or further embodiments, the mechanism comprises a first compartment in the pad configured to hold the illumination device and allow the illumination device to emit the light. For example, the first compartment may be integrated below or inside the cushion, so as to direct the light near the top of the pad.

In some embodiments, the pad comprises (i) a cushion having a generally planar surface, and (ii) an outer material. The outer material may be waterproof. For example, the outer material may comprise polyurethane, soft vinyl, treated cotton or polyester, or polytetrafluoroethylene (Teflon™). In various embodiments, the cushion comprises undulations or contours adapted to accommodate contours of the infant's body.

In some embodiments, the infant changing system further comprises a cover on or over the pad. The cover may be washable and/or removable. In other or further embodiments, the outer material and/or the cover includes a material and/or a window configured to control the direction and/or intensity of the light. In some examples, the first compartment may be integrated with the outer material or the cover.

In some embodiments, the infant changing system further comprises a second compartment configured to house electronics associated with the illumination device. The first compartment and/or the second compartment may be sealed at one end and may have an electrical connector and/or interface to connect the electronics (e.g., the illumination device) to a power source. The power source may comprise one or more batteries. In various embodiments, the battery or batteries are in the first compartment or the second compartment, and the first compartment or second compartment may have a closable lid to allow access to the batteries. The first compartment and/or the second compartment may be independently waterproof. The cover may be configured to hold the first compartment and/or second compartment.

In various embodiments, the infant changing system further comprises (1) a quick release mechanism configured to connect and disconnect the first compartment and/or the second compartment from the pad, the outer material or the cover, and/or (2) a pressure sensitive switch connected to the illumination device.

In some embodiments, the first compartment has a back wall and side walls comprising an opaque material, and a transparent wall facing a surface of the pad contacting the infant to direct the light towards the infant. The transparent wall may have a star, moon, geometric or other aesthetic shape. Alternatively, the illumination device may have a star, moon, geometric or other aesthetic shape. In other or further embodiments, the light is directed to a center of the surface of the pad contacting the infant, and the illumination device is placed above, below, or within the pad, or within the outer material or the cover.

In some embodiments, the illumination device extends asymmetrically from approximately a middle of the pad towards one end of the pad along a length of the pad. In other embodiments, the illumination device extends (i) symmetrically across a center of the pad and along a width of the pad or (ii) asymmetrically from approximately a middle of the pad towards one side of the pad along the width of the pad. The illumination device has a length and a width, and the length is generally greater than the width. For example, the length may be from ⅜ to 15 inches (1.0 to 28 cm) and the width may be of from ⅛ to 3 inches (0.3-7.5 cm).

In various embodiments, the illumination device (a) includes a tapered diffusion section in the pad, (b) comprises a light emitting diode (LED), and/or (c) receives an AC voltage. In other or further embodiments, the infant changing system further comprises (1) an integrated switch or power connect configured to turn the illumination device on and off and/or (2) a dimmer configured to control an intensity or power supplied to the illumination device. The illumination device may be waterproof.

In some embodiments, the infant changing system further comprises a controller configured to receive information from a sensor indicating a presence of the infant and turn on the illumination device in response thereto. For example, the sensor may comprise a load sensor, a proximity sensor, or an image sensor. In further embodiments, the infant changing system (e.g., the controller) may further comprise a timer that turns off the illumination device a predetermined time after the sensor no longer detects the presence of the infant, and the controller may be configured to process information from a wireless device.

In some embodiments, the pad is substantially planar on its major surfaces. Additionally or alternatively, the pad may have a rectangular, circular, oval, or other geometric shape.

In some embodiments, the pad has an infant contact surface and further comprises a wall extending above the infant contact surface to protect the infant. In some embodiments, the wall contains embedded lighting.

In some embodiments, the pad contains raised sections between the illumination device and the infant's eyes to block light from the infant's eyes. Alternatively or additionally, the pad comprises a material that controls light diffusion. The material may comprise polyester, cotton, or wool.

In some embodiments, the pad contains a semi-rigid section. For example, the semi-rigid section may comprise cardboard, plastic, or balsa wood.

In some embodiments, the infant changing system further comprises a heating element configured to warm the infant.

In some embodiments, the mechanism is configured to direct the light to the second predetermined area of the pad. For example, the mechanism may comprise a tube from the second predetermined area of the pad to the first predetermined area of the pad. In one embodiment, the second predetermined area of the pad is at an end of the pad opposite from the infant's head.

Another aspect of the present invention relates to a method of illuminating a diaper changing area of an infant comprising setting or placing an infant on a pad configured to support an infant during a diaper change and turning on an illumination device secured directly or indirectly to the pad or proximate to a first predetermined area of the pad. The illumination device is configured to emit light toward a second predetermined area of the pad. In some embodiments, the illumination device is secured to the pad in a first compartment in the pad configured to hold the illumination device and allow the illumination device to emit the light. Other aspects and/or embodiments of the infant changing system may apply to the present method of illuminating the diaper changing area of the infant.

Yet another aspect of the present invention relates to a method of changing a diaper of an infant, comprising the aforementioned method of illuminating a diaper changing area of an infant, and changing the diaper of the infant. In general, the infant's diaper is changed while the illumination device is on.

The present invention advantageously enables changing an infant's diaper nonintrusively by limiting the amount of light reaching the infant's eyes, preventing the infant from waking up or otherwise having its sleep affected.

### BRIEF DESCRIPTION OF THE DRAWINGS

FIG. 1 is a side view of a basic shape and components of a diaper changing pad without a light.

FIG. 2 is a side view of the diaper changing pad with a small or round light source located near the top of the pad.

FIG. 3 is a side view of the diaper changing pad with a small or round light source located near the center of the pad.

FIG. 4 is a side view of the diaper changing pad with a small or round light source located near the bottom of the pad.

FIG. 5 is a side view of the diaper changing pad with a thin and/or long light source located near the top of the pad.

FIG. 6 is a side view of the diaper changing pad with a thin and/or long light source located near the center of the pad.

FIG. 7 is a side view of the diaper changing pad with a thin and/or long light source located near the bottom of the pad.

FIG. 8 is a top down view of the diaper changing pad with a small or round light source located near the center of the pad.

FIG. 9 is a top down view of the diaper changing pad with a thin and/or long light source located near the center of the pad.

FIG. 10 is a top down view of the diaper changing pad with block forms that are located to further restrict light from reaching the infants eyes.

FIG. 11 is a side view of the diaper changing pad with a small compartment located near the top of the pad holding a light source.

FIG. 12 is a side view of the diaper changing pad with a small compartment located near the center of the pad holding a light source.

FIG. 13 is a side view of the diaper changing pad with a small compartment located near the bottom of the pad holding a light source.

FIG. 14 is a side view of the diaper changing pad with a thin and/or long compartment located near the top of the pad holding a light source.

FIG. 15 is a side view of the diaper changing pad with a thin and/or long compartment located near the center of the pad holding a light source.

FIG. 16 is a side view of the diaper changing pad with a thin and/or long compartment located near the bottom of the pad holding a light source.

FIG. 17 is a side view of the diaper changing pad with a compartment integrated into the pad outer material holding a thin light source such as an OLED.

FIG. 18 is a top down view of the diaper changing pad with a compartment integrated into the pad outer material holding a thin light source such as an OLED.

FIG. 19 is a side view of the diaper changing pad similar to FIG. 17 with a thinner and/or longer compartment.

FIG. 20 is a top down view of the diaper changing pad similar to FIG. 18 with a thinner and/or longer compartment.

FIG. 21 is a view of a removable mattress pad and/or sheet type cover shown with an integrated compartment to hold a thin light source such as an OLED and a compartment for batteries, electronics, controls, or other electronics.

FIG. 22 is similar to FIG. 21 but shows a thinner and/or longer compartment.

FIG. 23 is similar to FIG. 21 but shows the removable mattress pad and/or sheet-type cover with material of varying degrees of opacity and transparency, to allow light to pass through selected shapes, patterns, designs, and logos such as a moon in this example.

FIG. 24 is a view of a diaper changing pad with one side higher than the other, and a possible extra light source embedded into the higher side.

FIG. 25 is a side view of a diaper changing pad with the top outer material having varying degrees of opacity and transparency to allow light to pass through selected areas only.

FIG. 26 is a side view of a diaper changing pad showing the cushioning material having varying degrees of opacity and transparency to allow light to pass through selected areas only.

FIG. 27 is a side view of a diaper changing pad shown with varying degrees of the cushioning material removed to place a compartment and/or light source with varying degrees of light passing through the cushioning.

FIG. 28 is a top down view of a diaper changing pad shown with the outer material having varying degrees of opacity and transparency, allowing light to pass through the selected areas only, such as a moon shaped area in this case.

FIG. 29 is a top down view of a piece of material with varying degrees of transparency and opacity that is inserted into a sleeve on the top of the diaper changing pad, allowing light to pass through the selected areas only, such as a moon shaped area in this case.

FIG. 30 is a top down view of the diaper changing pad shown in FIG. 29 inserted into a sleeve in the topside of the pad and the effect of the inserted pad on the light that is allowed to pass through.

FIG. 31 is a side view of a diaper changing pad shown with an inserted light source apparatus.

FIG. 32 is a view of an insertable light source apparatus as inserted in FIG. 31, with a light source, battery and/or control compartment, and attachment devices.

FIG. 33 is a side view of a diaper changing pad with an integrated compartment to hold a light source apparatus such as in FIG. 31 to be inserted.

FIG. 34 is a side view of a diaper changing pad with a compartment for batteries.

FIG. 35 is a side view of a diaper changing pad with a compartment for various electronics and controls.

FIG. 36 is a side view of a diaper changing pad with an example of a dimmer switch, an AC or DC adapter, and a wall plug.

FIG. 37 is a top down view of a basic rectangular shaped diaper changing pad with raised edges on opposed sides, in contrast to another form that may have raised edges on all sides.

FIG. 38 is a top down view of a basic oval shaped diaper changing pad with raised borders.

FIG. 39 is a top down view of a rectangular shaped diaper changing pad with one side raised higher than the other.

FIG. 40 is a perspective view showing an example light source compartment that helps control the lighting direction and intensity with a light source being directed in one direction and the top cover being of varying opacity and/or transparency.

FIG. 41 is a perspective view showing an example light source compartment that uses varying opacity and/or transparency on the top cover to help control light distribution with the light source or the compartment shaped like a moon.

FIGS. 42A-D are side views of several embodiments showing the light source attached to the pad with tape, snaps, hook and loop fasteners, clip harnesses, or metal prongs pushed into the pad.

FIG. 43 is a side view of an embodiment showing the light source in a compartment between the cushion and a semi-rigid bottom or support material, in which the compartment may be attached to the semi-rigid bottom or support material with tape, snaps, hook and loop fasteners, clip harnesses, or metal prongs pushed into the pad.

FIG. 44 is a side view of an embodiment in which the pad and/or cushion is sloped in a manner raising the head support area of the pad (e.g., to minimize any overflow of a full diaper up the infant's back).

FIG. 45 is a perspective view of an embodiment including a mechanism (e.g., a tube) such as a tube configured to direct the light from an external light source to the diaper changing area of the pad.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

Unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The present invention relates to an infant changing system. The infant changing system comprises a pad configured to support an infant during a diaper change, an illumination device configured to emit light toward or from a first predetermined area of the pad, and a mechanism configured to secure the illumination device directly or indirectly to the pad, or to direct the light to a second predetermined area of the pad different from the first predetermined area of the pad. In one aspect, an illuminated infant diaper changing system utilizing an integrated light source is provided.

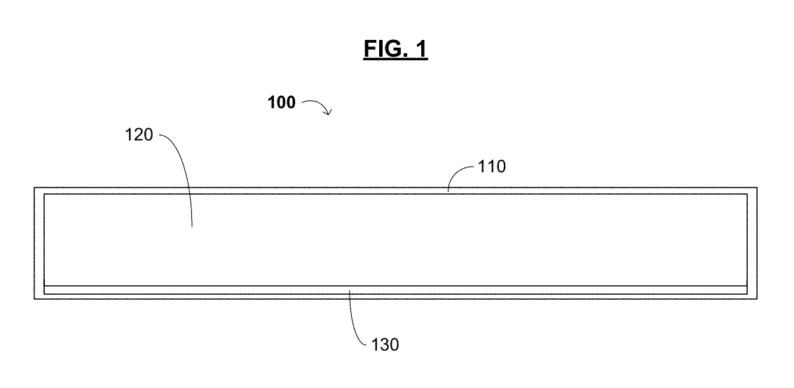

In one embodiment of the pad, the pad includes a cushioned substrate having a body and a substantially and generally planar surface as shown in FIG. 1. FIG. 1 shows a side view of the changing pad 100 with an outer material 110, a cushion 120, and a semi-rigid section 130. The outer material 110 may be waterproof and may comprise polyurethane, soft vinyl, treated cotton or polyester, or polytetrafluoroethylene. The cushion 120 may have a generally planar surface and may comprise undulations or contours adapted to accommodate contours of the infant's body. The semi-rigid section 130 may comprise cardboard, plastic, or balsa wood.

Alternatively, the surface of the pad 100 may comprise undulations and contours to accommodate the infant's body, including the infant's buttocks, neck and head. The substrate may include a compartment embedded in the body. The light source may be contained in a compartment as in FIGS. 11-16.

FIG. 11 shows a side view of a changing pad 100a including the outer material 110, a cushion 120a, and the semi-rigid section 130. A compartment 1100a holding a light source 1120 is integrated into the cushion 120a near the top of the changing pad 100a. The compartment 1100 may be waterproof.

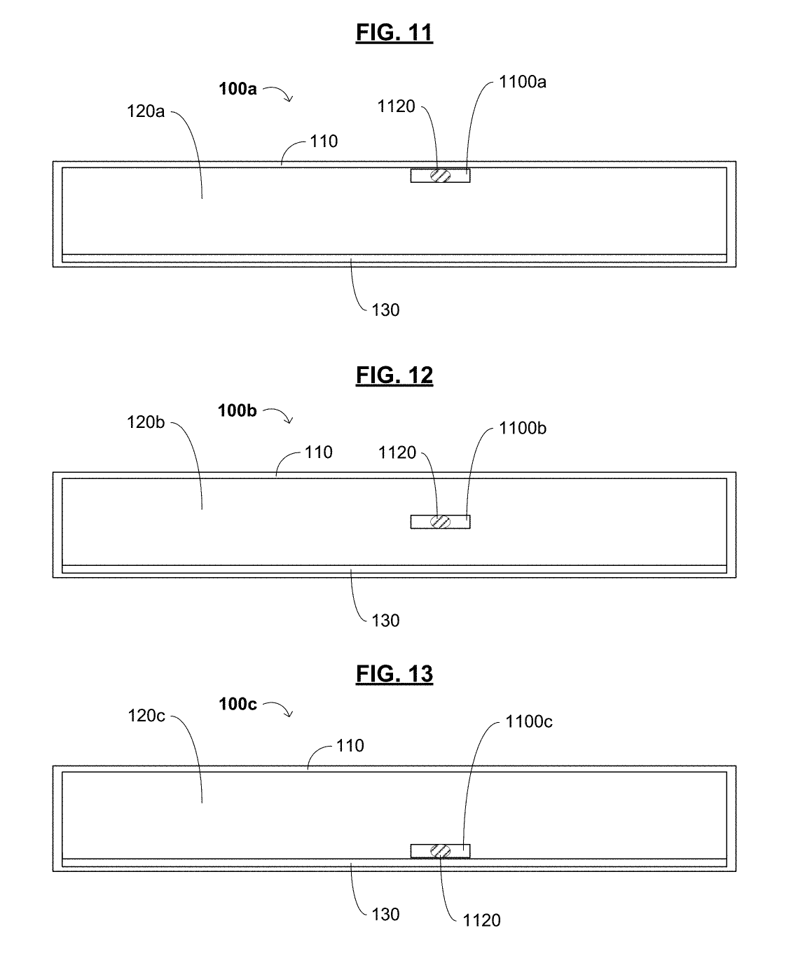

FIG. 12 shows a side view of a changing pad 100b including the outer material 110, a cushion 120b, and the semi-rigid section 130. The compartment 1100b holding the light source 1120 is integrated into the cushion 120b near the center of the changing pad 100b.

FIG. 13 shows a side view of a changing pad 100c including the outer material 110, a cushion 120c, and the semi-rigid section 130. A compartment 1100c holding the light source 1120 is integrated into the cushion 120c near the bottom of the changing pad 100c.

FIG. 14 shows a side view of a changing pad 100d including the outer material 110, a cushion 120d, and the semi-rigid section 130. A compartment 1100e holding a long and thin light source 1400 is integrated into the cushion 120d near the top of the changing pad 100d.

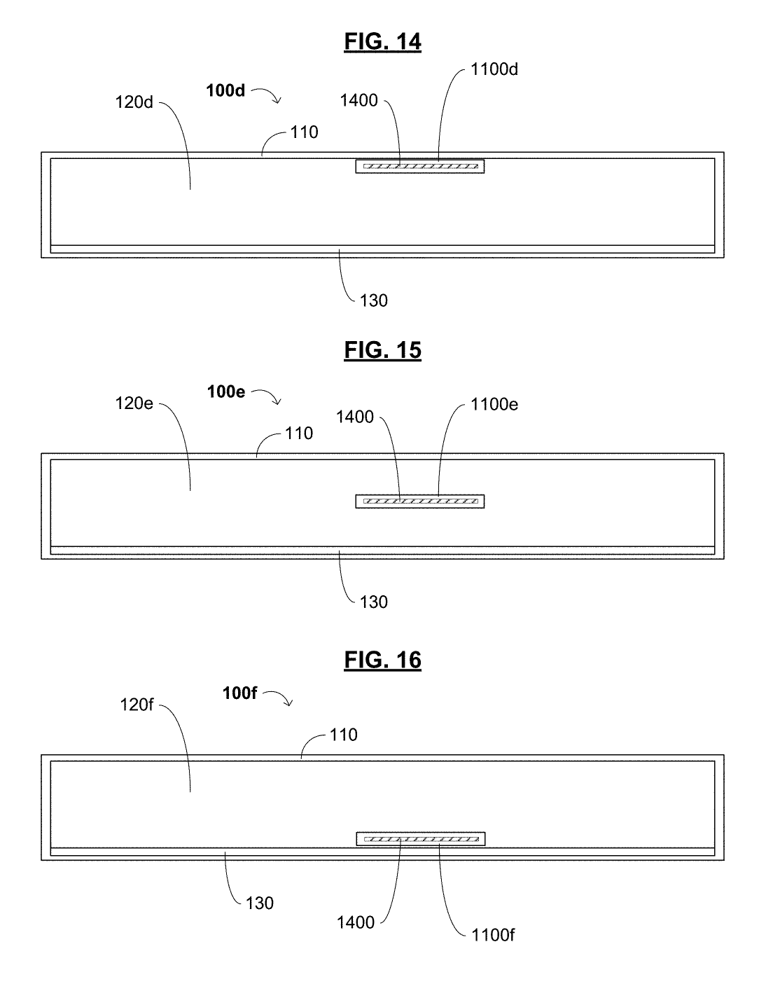

FIG. 15 shows a side view of a changing pad 100e including the outer material 110, a cushion 120e, and the semi-rigid section 130. A compartment 1100d holding the long and thin light source 1400 is integrated into the cushion 120e near the center of the changing pad 100e.

FIG. 16 shows a side view of a changing pad 100f including the outer material 110, a cushion 120f, and the semi-rigid section 130. A compartment 1100f holding the long and thin light source 1400 is integrated into the cushion 120f near the bottom of the changing pad 100f.

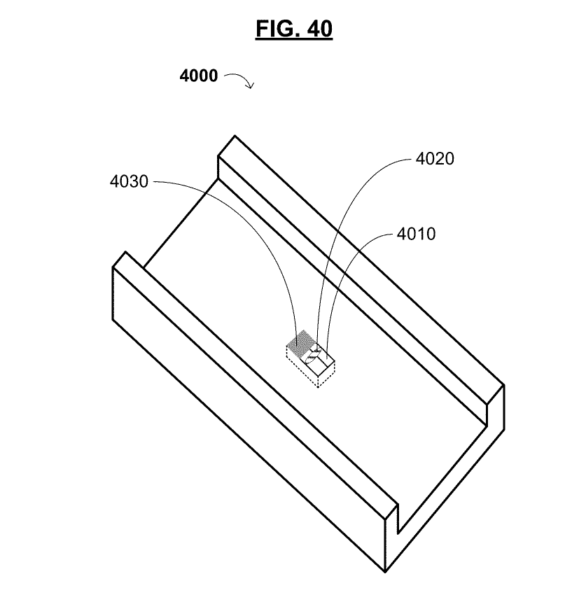

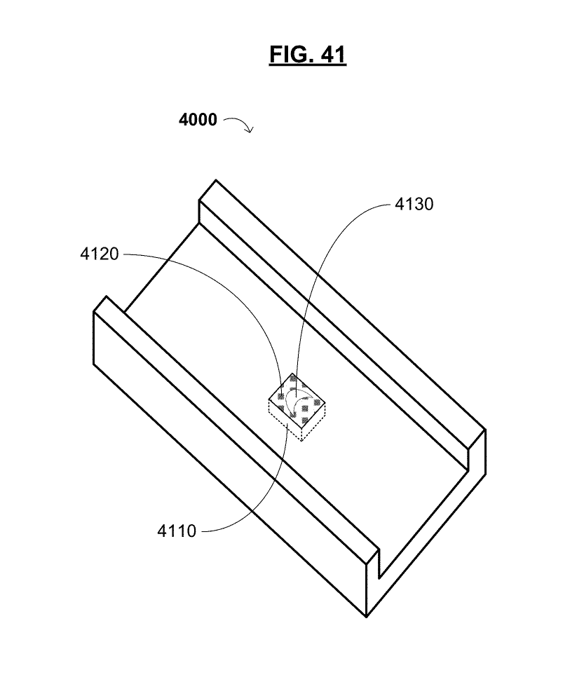

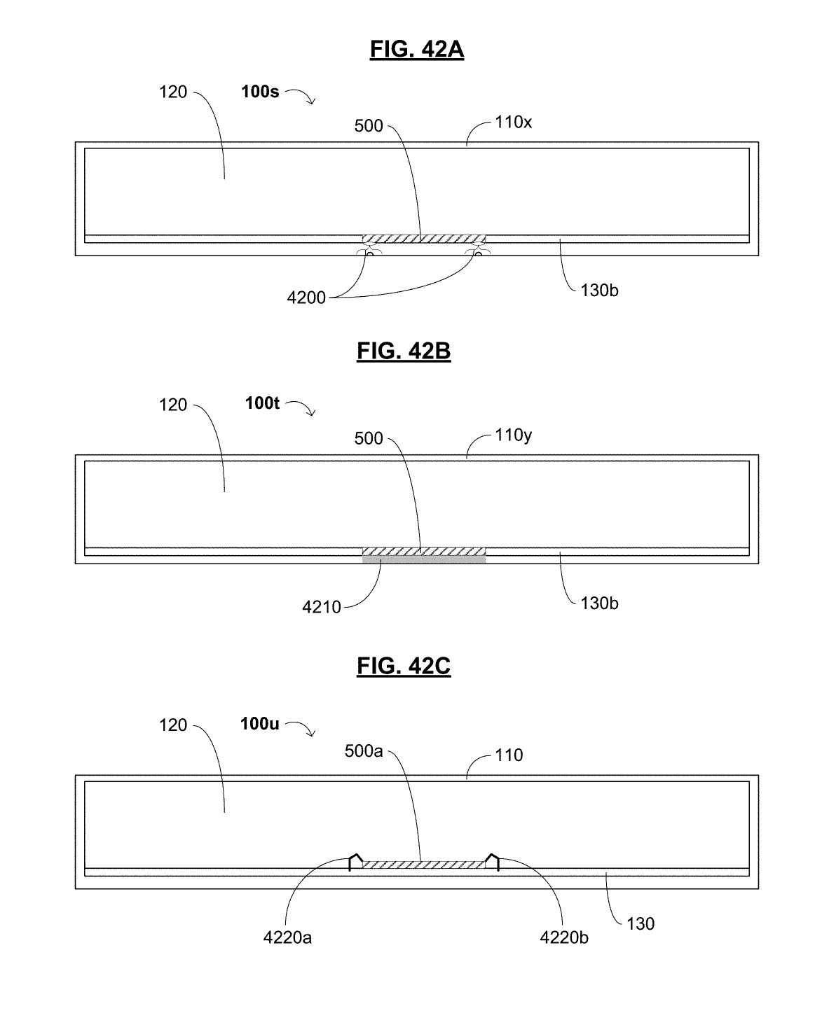

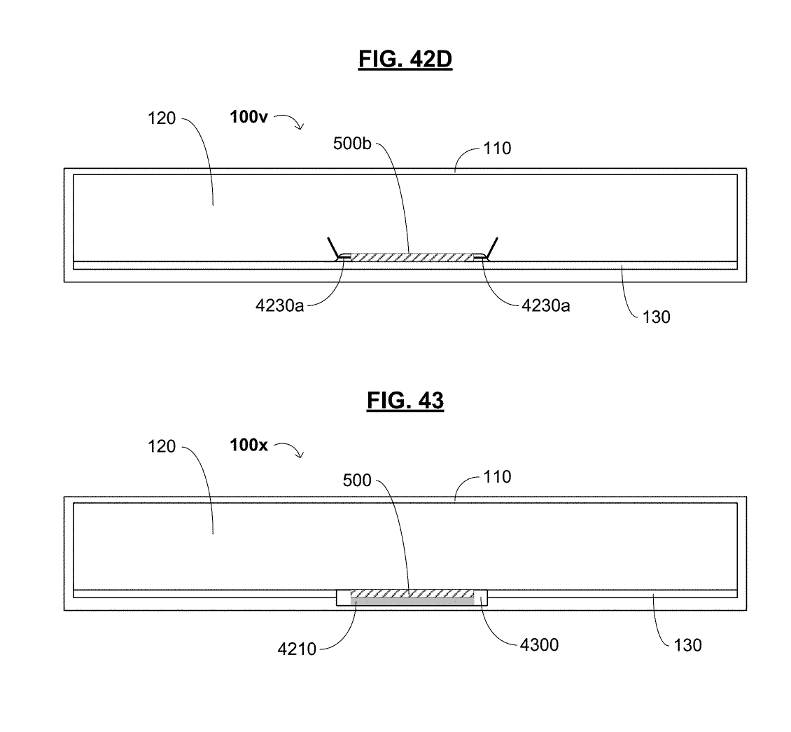

The compartment may include a cover configured to control the light source in direction or intensity to illuminate a predetermined area of the substrate, shown as in FIG. 40. FIG. 40 shows a changing pad 4000 with a compartment 4010 holding a light source 4020 and having an opaque cover 4030. The opaque cover 4030 blocks light emitted toward the head of an infant resting on the changing pad 400 and directs light towards the diaper area of the infant. The compartment 4010 may be water proof. The opaque cover 4030 may be washable.

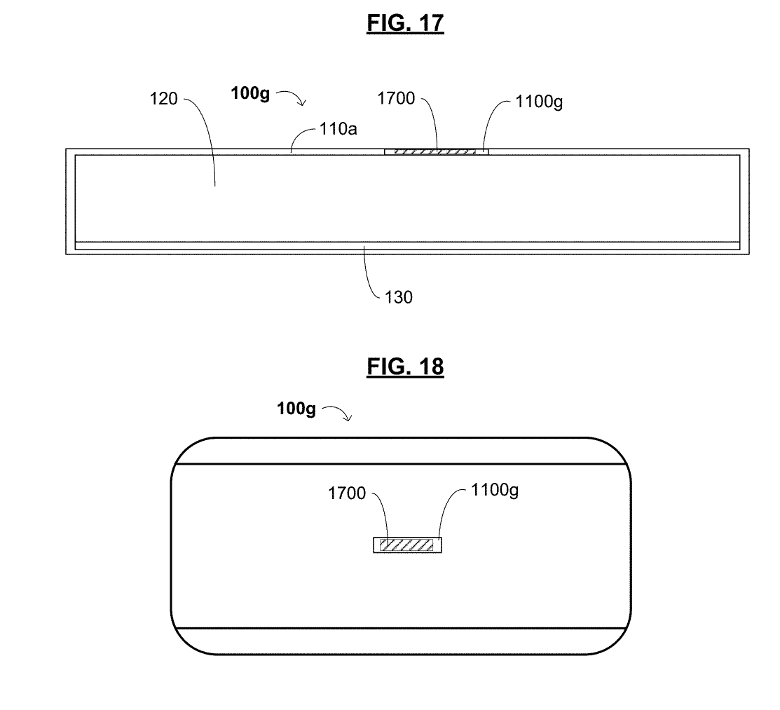

In one embodiment, the light source and the compartment may reside below or inside the cushion as shown in FIGS. 12, 13, 15, and 16 to diffuse light, or near the top of the pad as in FIGS. 11 and 14. In another embodiment, the light source and compartment may be integrated with the outer material of the pad, as shown in FIGS. 17, 18, 19, 20, and 33.

FIG. 17 shows a side view of a changing pad 100g including an outer material 110a, the cushion 120, and the semi-rigid section 130. A compartment 1100g holding a thin OLED light source 1700 is integrated into the outer material 110a on top of the changing pad 100g.

FIG. 18 shows a top down view of the changing pad 100g. The compartment 1100g holding a thin OLED light source 1700 is integrated into the top of the changing pad 100g.

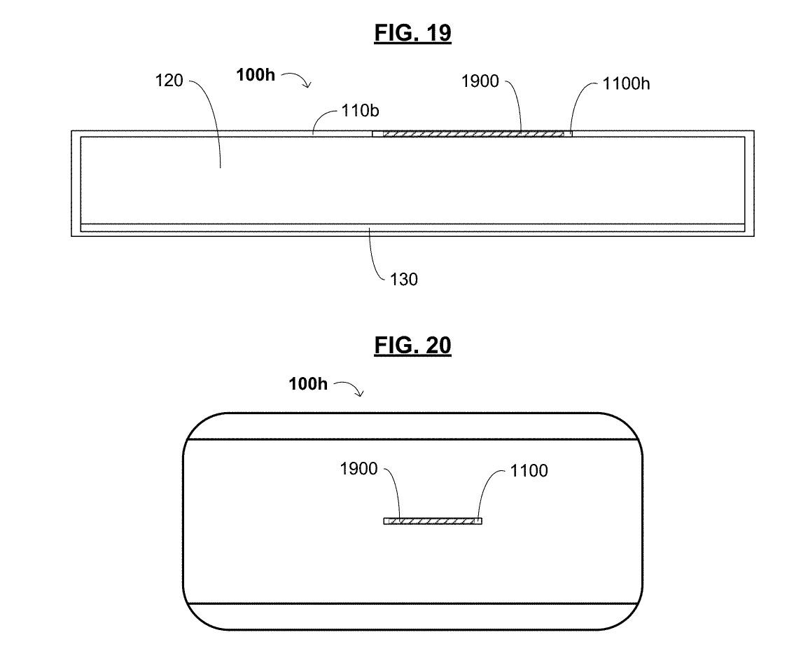

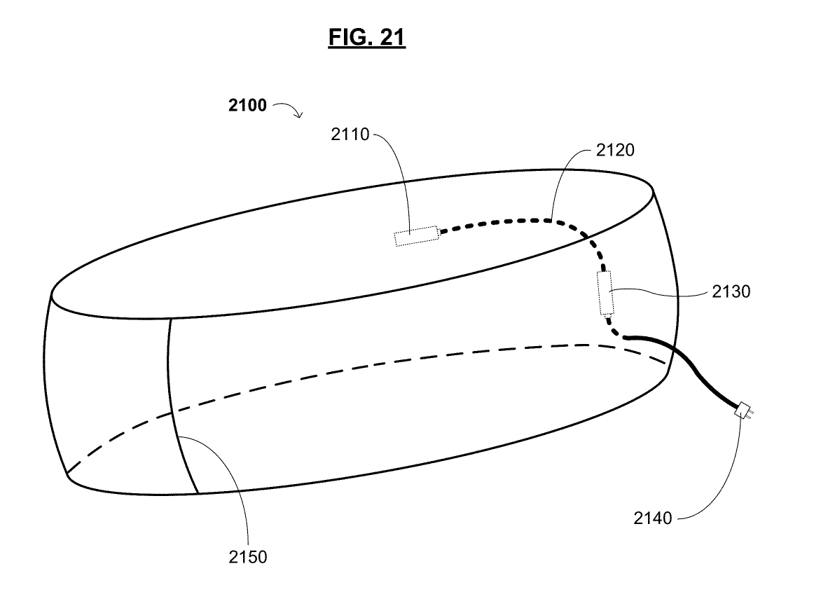

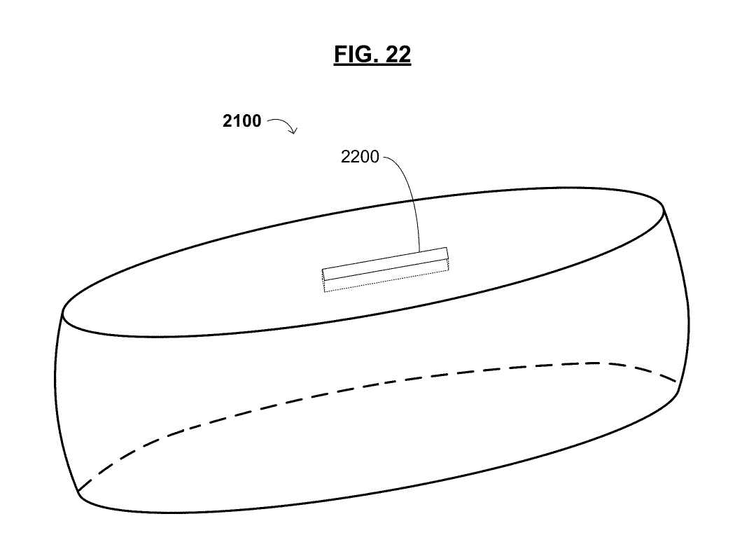

FIG. 19 shows a side view of a changing pad 100h including an outer material 110b, the cushion 120, and the semi-rigid section 130. A compartment 1100h holding a long and thin light source 1900 is integrated into the outer material 110b on top of the changing pad 100h.

FIG. 20 shows a top down view of the changing pad 100h. The compartment 1100h holding the long and thin light source 1900 is integrated into the top of the changing pad 100h.

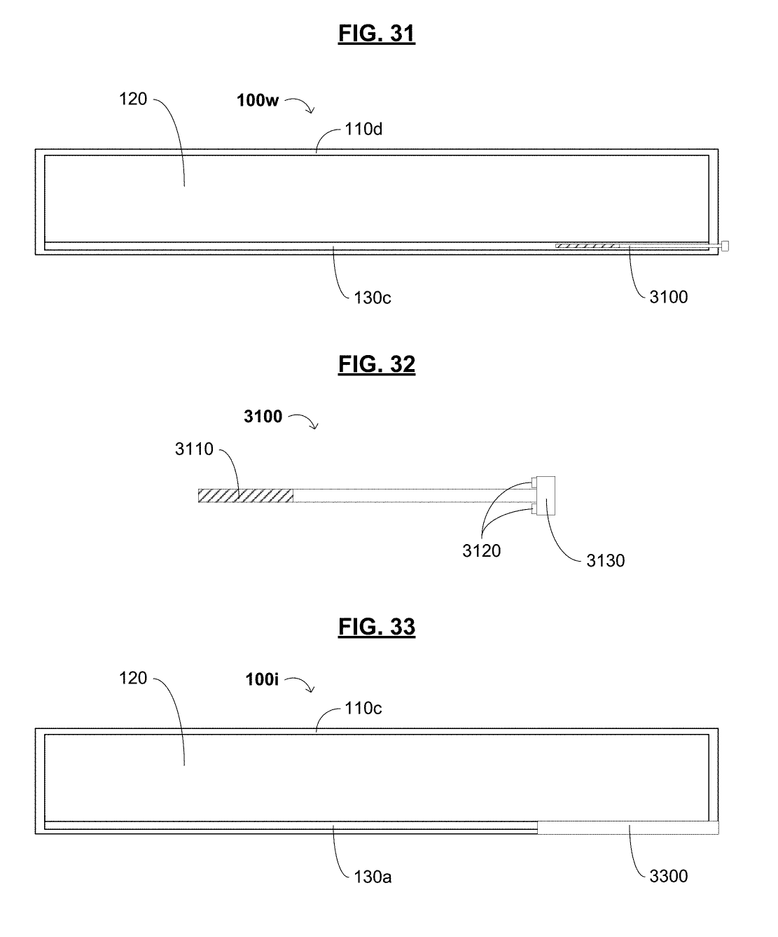

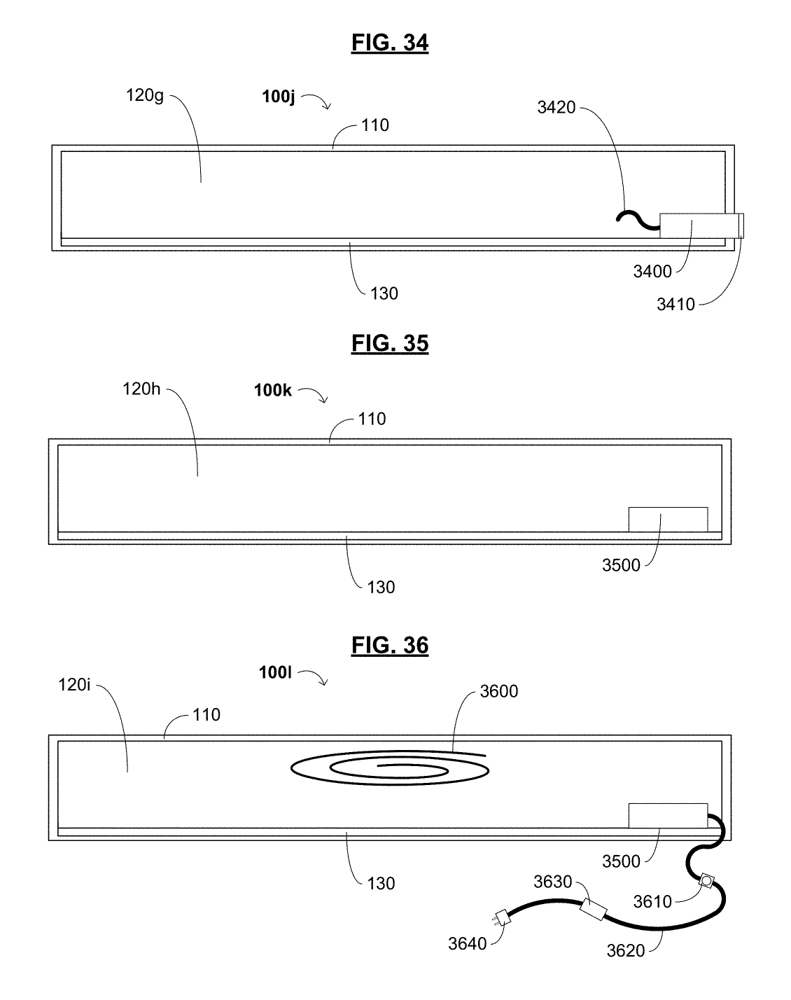

FIG. 33 shows a side view of a changing pad 100i including an outer material 110c, the cushion 120, and a semi-rigid section 130a. A compartment 3300 configured to hold an insertable device (e.g., illumination device 3100 of FIG. 32) is integrated into the bottom of the changing pad 100i, below the cushion 120. The compartment 3300 may be waterproof.

Additionally, the pad may include a second compartment to contain electronics associated with the lighting system, as shown in FIGS. 34-36.

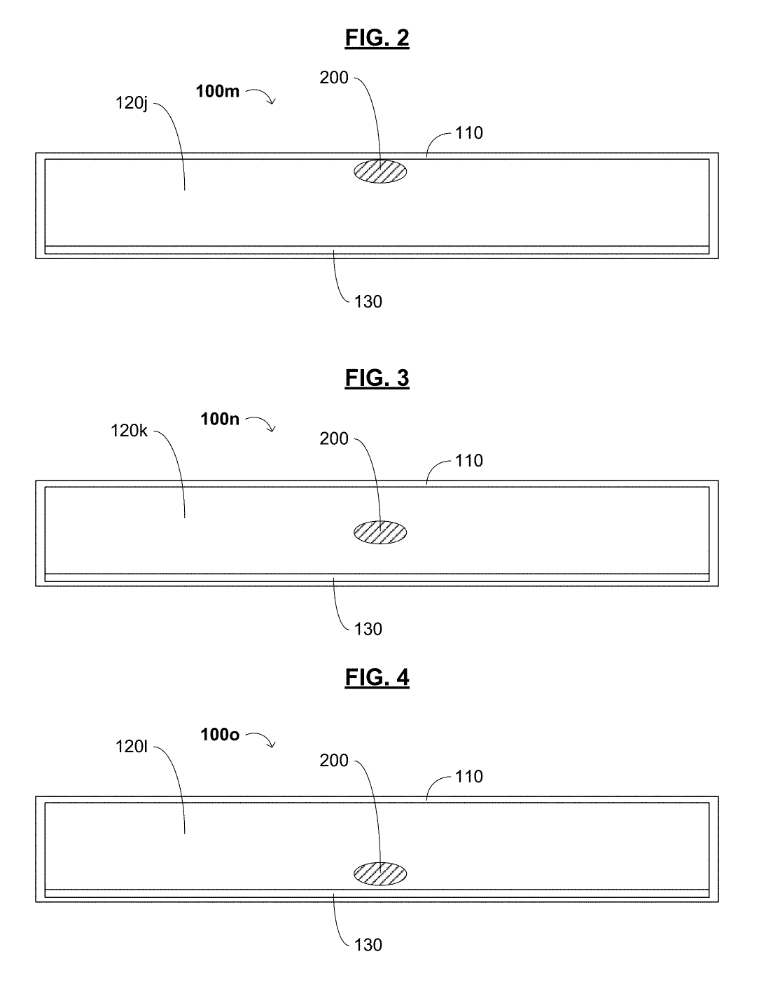

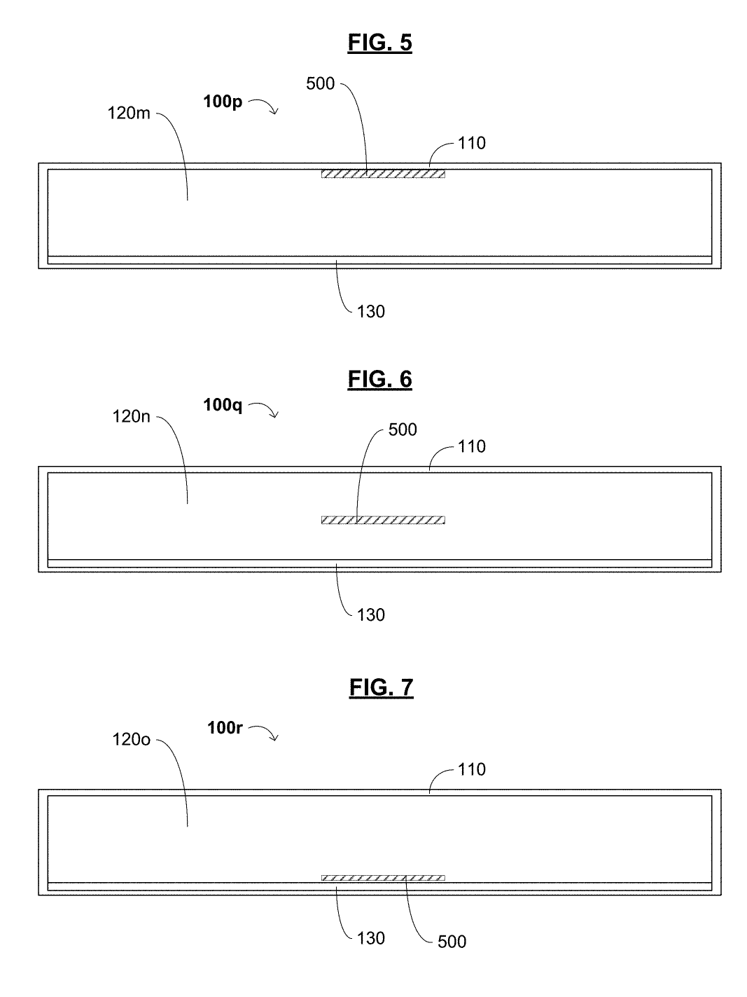

FIG. 34 shows a side view of a changing pad 100j including the outer material 110, a cushion 120g, and the semi-rigid section 130. A compartment 3400 configured to hold batteries may include an access lid 3410 external to the changing pad 100j, and is positioned in a lowermost, outermost region of the changing pad 100j, below the cushion 120h. A wire 3420 is configured to be connected to a light source (e.g., the light source 200 of FIG. 2 or the light source 500 of FIG. 5). The compartment 3400 may be waterproof.

FIG. 35 shows a side view of a changing pad 100k including the outer material 110, a cushion 120h, and the semi-rigid section 130. A compartment 3500 is configured to hold a light source, various electronics and user controls in a lowermost region of the changing pad 100k, below the cushion 120h. The compartment 3500 may be waterproof.

FIG. 36 shows a side view of a changing pad 100l including the outer material 110, a cushion 120i, the semi-rigid section 130, the compartment 3500, a heating element 3600, a dimmer switch 3610, an electrical cord 3620, an alternating current (AC) and/or direct current (DC) power adapter 3630, and a plug 3640. The heating element 3600 is configured to warm the infant and is integrated near the top of the changing pad 100l. For safety purposes, the heating element 3600 may have a max temperature of 35-40° C. The dimmer switch 3610 is configured to control the emission of light from a light source contained in the compartment 3500 (e.g., the light can be adjusted on a sliding scale from 0-100% brightness or at predetermined percentage settings, such as 25%, 50%, 100%, etc.). The AC/DC power adapter 3630 is configured to supply power to the light source, various electronics, and user controls contained in compartment 3500. The plug 3640 is configured to be plugged into a conventional wall outlet (e.g., supplying a 110V or 220V current). The electrical cord 3620 electrically connects the electronics in the compartment 3500, the dimmer switch 3610, the AC/DC power adapter 3630, and the plug 3640.

Either compartment may be waterproof. Either compartment may be sealed with an end having an electrical connector interface to connect with a power source. Alternatively, an electrical cord may be connected to electronics in (and, e.g., at the end of) either compartment. In another embodiment, the light source may be powered by one or more batteries, and the second compartment may have a closable lid to allow access to the one or more batteries in an event where the one or more batteries need to be replaced as in FIG. 34.

In one embodiment, the light source may be placed in the body of the pad (e.g., the cushion) without a compartment. Additionally or alternatively, the lighting may be placed under, within, or above the padding, as shown in FIGS. 2-9 and 24.

FIG. 2 shows a side view of a changing pad 100m including the outer material 110, a cushion 120j, and the semi-rigid section 130. A light source 200 is integrated into the cushion 120j near the top of the changing pad 100m (e.g., in an upper most region of the cushion 120j).

FIG. 3 shows a side view of a changing pad 100n including the outer material 110, a cushion 120k, and the semi-rigid section 130. The light source 200 is integrated into the cushion 120k near the center of the changing pad 100n (e.g., in a center region of the cushion 120k).

FIG. 4 shows a side view of a changing pad 100o including the outer material 110, a cushion 120l, and the semi-rigid section 130. The light source 200 is integrated into the cushion 120l near the bottom of the changing pad 100o (e.g., in a lowermost region of the cushion 120l).

FIG. 5 shows a side view of a changing pad 100p including the outer material 110, a cushion 120m, and the semi-rigid section 130. A long and thin light source 500 is integrated into the cushion 120m near the top of the changing pad 100p (e.g., in an uppermost region of the cushion 120m).

FIG. 6 shows a side view of a changing pad 100q including the outer material 110, a cushion 120n, and the semi-rigid section 130. The long and thin light source 500 is integrated into the cushion 120n near the center of the changing pad 100q (e.g., in a center region of the cushion 120n).

FIG. 7 shows a side view of a changing pad 100r including the outer material 110, a cushion 120o, and the semi-rigid section 130. The long and thin light source 500 is integrated into the cushion 120o near the bottom of the changing pad 100r (e.g., in a lowermost region of the cushion 120o).

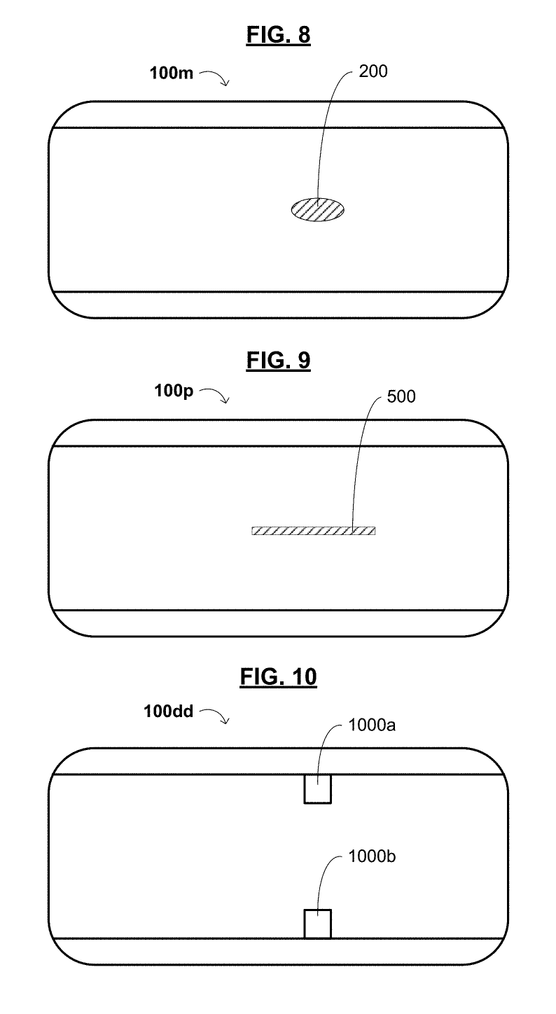

FIG. 8 shows a top down view of the changing pad 100m (FIG. 2). The light source 200 is integrated into the top of the changing pad 100m.

FIG. 9 shows a top down view of the changing pad 100p (FIG. 5). The long and thin light source 500 is integrated into the top of the changing pad 100p.

FIG. 24 shows a changing pad 2400 with a higher side 2410 and a lower side 2420. The light source 200 may be integrated into the higher side 2410.

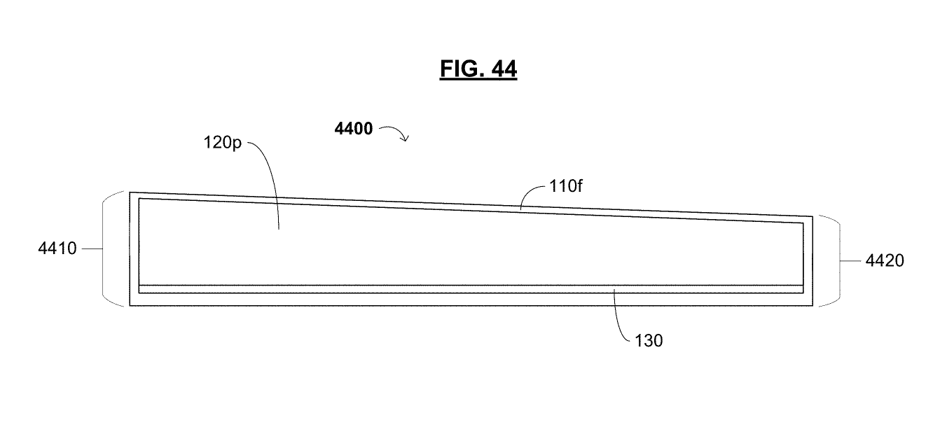

The light source may be attached to the pad, the pad outer material, or a cover or sheet over the pad and/or pad outer material with tape, hook and loop fasteners, snaps, clip harnesses, or metal prongs pushed into the pad, as shown in FIG. 42A-D. FIG. 42A shows a side view of a changing pad 100s including an outer material 110x, the cushion 120, a semi-rigid section 130b, and the thin and long light source 500. Snap attachments 4200 secure the light source 500 to the outer material 110x. FIG. 42B shows a side view of a changing pad 100t including an outer material 110y, the cushion 120, the semi-rigid section 130b, and the thin and long light source 500. A double sided tape or hook and loop fastener 4210 secures the light source 500 to the outer material 110y. FIG. 42C shows a side view of a changing pad 100u including the outer material 110, the cushion 120, the semi-rigid section 130, and a thin and long light source 500a. One or more clips or harnesses 4220a-b secure the light source 500a to the rigid section 130. FIG. 42D shows a side view of a changing pad 100v including the outer material 110, the cushion 120, the semi-rigid section 130, and a thin and long light source 500b. Metal prongs 4230a-b connected to or integrated into the light source 500a are pushed into the cushion 120 to secure the light source 500b to the underside of the cushion 120.

In one embodiment, the compartment that holds the light source is waterproof. The waterproof compartment may include a quick release mechanism that easily disengages the waterproof compartment from the pad or various covers. The waterproof compartment may include a pressure sensitive switch or any other electronics connected to the light source. The waterproof compartment may be sealed with the end of the compartment having an electrical connector interface to plug a cord into, or an electrical cord may be connected to the waterproof compartment. The waterproof compartment may be shaped and located to hold the light source. All of the various embodiments of the compartment may be waterproof. The waterproof compartment may be integrated with the outer material of the pad, or the waterproof compartment may be integrated with a separate cover such as a traditional mattress cover, topper, pad, or sheet as shown in FIG. 21.

FIG. 21 shows a removable mattress pad or sheet-type cover 2100 with a compartment 2110 to hold a light source, a compartment 2130 to hold a battery, a power supply, or other electronics, a cable or wire 2120 to connect the battery, the power supply or other electronics in the compartment 2130 to the light source in compartment 2110, and a wall plug 2140 to power the battery, the power supply, the other electronics, or the light source. The compartments 2110 and 2130 may be waterproof. The removable mattress pad or sheet-type cover 2100 may be washable.

FIG. 22 shows the removable mattress pad or sheet-type cover 2100 with a compartment 2200 that is longer than the compartment 2110 in FIG. 21. The compartment 2200 may be waterproof.

With reference to FIG. 41, another aspect of the light source may be provided wherein the light source may be enclosed in a compartment dimensioned to have a geometric or aesthetic shape, such as a star or crescent moon. FIG. 41 shows a changing pad 4000 with a compartment 4110 having an opaque cover 4120 with a transparent decorative shape section 4130 (e.g., a moon in this case). The compartment 4110 may contain a light source. In other embodiments, the light source may have a decorative shape such as a star, a moon, or other geometric or aesthetic shape. The compartment 4110 may be waterproof. The opaque cover 4120 may be washable.

The compartment may be made of a material with varying degrees of material transparency and opacity to create light in the desired shape, and the absence of light elsewhere. The cover or pad outer material may be washable and may have any of varying colors, thicknesses, and materials to facilitate light diffusion toward targeted areas and light restriction otherwise, as may be possible in all other aspects and forms of the invention.

In another embodiment, the light source may be centered in the middle of the pad. The light source may be placed under, within, or above the padding, or within the pad outer material or within a washable removable traditional mattress type cover as mentioned previously in FIGS. 2, 3, 4, 8, 17, 18, and 21. In other embodiments, the light source may extend asymmetrically from approximately the middle of the pad towards one end of the pad along its length. The long axis of the asymmetric lighting may be centered along the width. The light source may be longer along its length and shorter along its width, such that the light source comprises a strip having a length from 1 to 15 inches (2.5 to 28 cm) and a width from ⅛ to 3 inches (0.3-7.5 cm). Additionally, such a strip may be placed under, within, or above the padding, or within the pad outer material or within a washable traditional mattress type cover as in FIGS. 5, 6, 7, 9, 19, 20, and 22. The light source may be disposed along a side of the pad as shown in FIG. 24, in conjunction with a center light source as shown in FIGS. 8-9.

The pad may comprise an insertable flashlight-like device. The device may include a long tapered diffusion section that fits into a hole in the pad, as shown in FIGS. 31-33. The device may include a compartment that may be inserted into the pad first, or the pad itself may have the compartment designed and built in. Additionally, the device may include sticky tape, hook and loop fasteners (e.g., Velcro), snaps or other mechanisms to secure the device to the pad as shown in FIGS. 42A-D.

FIG. 31 shows a side view of a changing pad 100w including an outer material 110d, the cushion 120, and a semi-rigid section 130c. An insertable device 3100 is inserted near the bottom of the changing pad 100w (e.g., into a slot or a cut-out in the semi-rigid section 130c), and may contain a light source and batteries. The outer material 110d has an opening to receive the insertable device 3100. The outer material 110d or the semi-rigid section 130c has a complementary fitting for the securing mechanism 3120 (although the cushion 120 should receive any prongs). FIG. 32 shows the insertable device 3100 that includes a light source 3110, a compartment 3130 to hold a battery or power supply, and a securing mechanism 3120 as described herein to keep the insertable device 3100 attached the changing pad 100. The compartment 3130 may be waterproof.

In various embodiments, the light source may be a low voltage DC light, such as an LED or OLED, or an AC light. The light source may be turned on and off with an integrated switch or power connector. The light source may include a dimmer, as shown in FIG. 36. The light source may be configured to adjust or select the color of the lights (e.g., towards red, green, or black light) to lessen the effect of the light in nighttime or military applications, or, in the case of black lighting, to see liquids better. The dimmer may include a gradual increase of light when the light source turns on, or apply one of a plurality of predetermined power/current settings (e.g., 25%, 50%, or 100% of full power or current). The light source may be waterproof.

In one embodiment, the lighting source may be automatically controlled. For instance, the light source may be in communication with a controller which receives information from a sensor that may be used to detect the presence of an infant. Such a sensor may include a load sensor for detecting a load on the pad, or a proximity sensor such as an infrared sensor, or an image sensor. It may be appreciated that any sensor that is currently known or used, or later developed, that is configured to detect the presence of an infant may be modified and adapted for use herein. Additionally, the lighting system may include a timer to shut off automatically a predetermined amount of time (e.g., five minutes) after the baby has been removed from the illuminated diaper changing system.

In one embodiment, the system may be battery operated with one or more rechargeable or disposable batteries, or powered using any combination of battery or batteries, AC power, DC power, wall outlet, etc. Additionally, a battery system may be integrated with the pad or cover. Additionally, a battery system in the pad or cover may be in a waterproof pocket or compartment with similar features as the compartment described earlier with respect to FIGS. 34-36.

In various embodiments, the lighting system may be controlled remotely. Additionally, the light source may utilize a wireless connection such as Bluetooth or Wi-Fi to be controlled by a phone app, computer, baby monitor or other electronic system with a processing or network capability. Additionally, the remote control system or a separate system may be capable of detecting a baby's cry during preset nighttime hours to automatically illuminate the diaper changing system.

In various embodiments, the pad may be planar on the bottom, with the topside as follows. In one embodiment, the illuminated diaper changing system comprises a primarily planar topside surface along the primary, long axis (hereinafter referred to as the length), and having somewhat concave surfaces across the secondary, shorter axis (hereinafter referred to as the width). Additionally, the shape may be mostly planar with a concave form on both axes on the topside of the pad. Alternatively, the illuminated diaper changing system comprises a mainly planar surface everywhere with raised edges along the length, on the topside of the pad. It may be understood that the pad may have a rectangular, circular, oval, or other shape, for example as shown in FIGS. 37, 38 and 40.

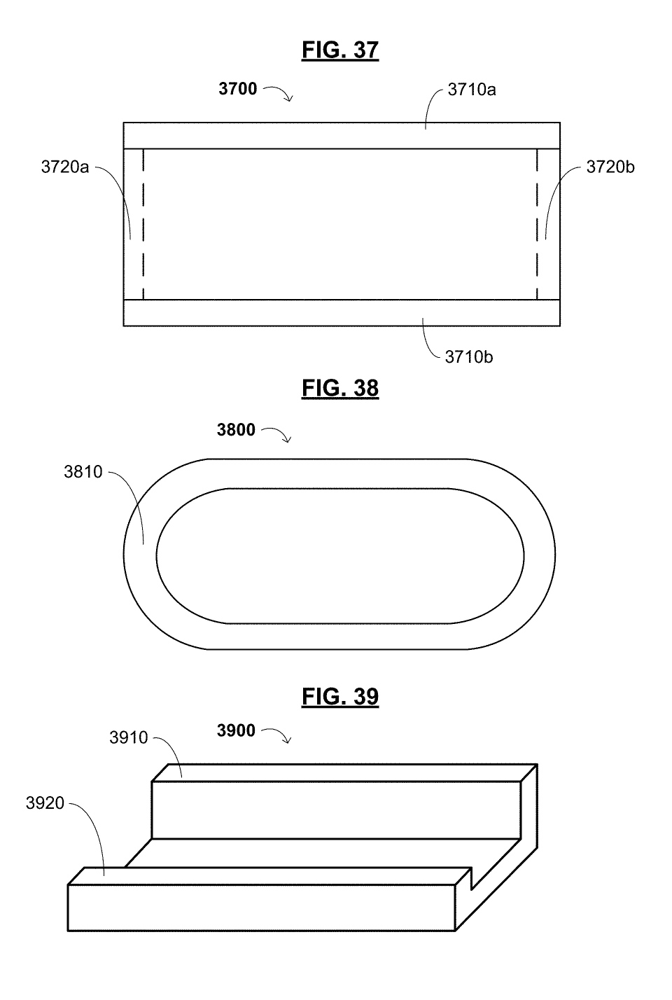

FIG. 37 shows a top down view of a rectangular changing pad 3700 with raised edges 3710a and 3710b along its length. The rectangular changing pad 3700 may optionally include raised edges 3720a and 3720b along its width. FIG. 38 shows a top down view of an oval changing pad 3800 with a raised edge 3810.

In another embodiment, one edge along the topside length may be taller than the other to create a barrier for the baby's hands and feet from coming into contact with items along a wall such as curtains, cords, or wall outlets, as shown in FIG. 39. FIG. 39 shows a rectangular changing pad 3900 with raised edges 3910 and 3920. The raised edge 3910 extends higher than the raised edge 3920. The raised taller edge 3910 may further contain embedded lighting, as shown in FIG. 24. Alternatively, the pad may include two raised topside sections along the width from the edges of the pad toward the center of the pad to further minimize light reaching the infants eyes, as shown in FIG. 10. An infant's body may be placed in a gap between the two raised topside sections. FIG. 10 shows a top down view of the changing pad 100dd. Block forms 1000a and 1000b extend from the top of the changing pad 100dd.

In various embodiments, the pad may comprise polyester fill or foam, cotton, wool, or any other suitable material for comfort and light diffusion or control, as shown in FIG. 1. The pad comprises a semi-rigid section 130 such as (but not limited to) cardboard, plastic, or balsa wood, as shown in FIGS. 1 and 43.

FIG. 43 shows a side view of a changing pad 100x including an outer material 110e, the cushion 120, a semi-rigid section 130d, and the light source 500. A compartment 4300 holds the light source 500, and a double-sided tape or hook-and-loop fastener 4210 secures the light source 500 to the compartment 4300. The double sided tape or hook and loop fastener 4210 may be replaced with snap attachments 4200, clips or a clip harness 4220, or metal prongs 4230 to secure the light source 500 to the compartment 4300. The compartment 4300 may be waterproof.

In another embodiment, the pad may be elevated at the child's head to minimize any overflow of a full diaper up the infant's back, as shown in FIG. 44. A pad 4400 may be elevated with a sloped cushion 120p (e.g., having a greater thickness at the head end than at the feet end). Alternatively, the pad 4400 may include one or more shims at the head end (e.g., between the cushion 120p and the semi-rigid section 130d). FIG. 44 shows a side view of the sloped changing pad 4400 including an outer material 110f, the sloped cushion 120p, and the semi-rigid section 130. The changing pad 4400 has a longer edge 4410 and a shorter edge 4420, so that when an infant is placed on the slanted changing pad 4400, the infant's head is placed closer to the longer edge 4110 and is elevated relative to its feet, which are placed closer to the shorter edge 4120.

In various embodiments, the pad comprises a water resistant or waterproof outer material such as but not limited to polyurethane, soft vinyl, treated cotton or polyester, or polytetrafluoroethylene (e.g., GORE-TEX® fabric). In other or further embodiments, the pad contains a heating element for the infant's comfort, as shown in FIG. 36.

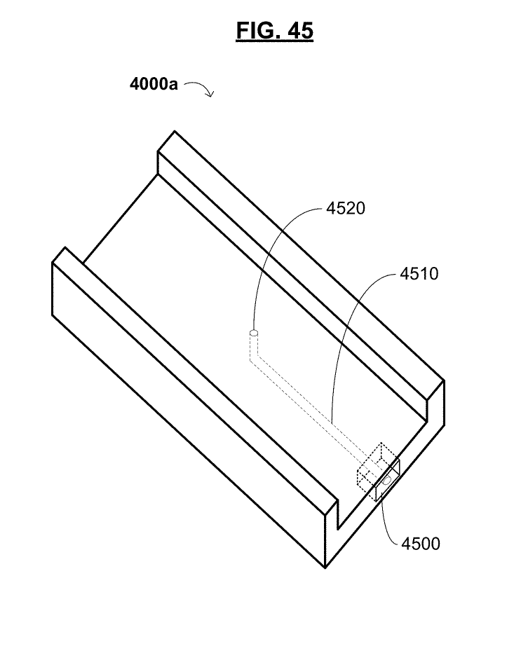

In another embodiment, the compartment may comprise a light tube that receives light from the end of the pad. A user may place a cell phone flashlight, a conventional flashlight or other external light source in the compartment and transfer light using the light tube to a selected portion of the pad, as shown in FIG. 45. FIG. 45 shows a changing pad 4000a with a compartment 4500, a light tube 4510 and an opening 4520. A light (such as a light from a flashlight or a smartphone) may be placed in the compartment 4500, and the light therefrom shines into the light tube 4510. The light tube 4510 may be constructed out of glass or other light transmitting medium. The light tube 4510 emits light toward the top of the changing pad 4000a through the opening 4520.

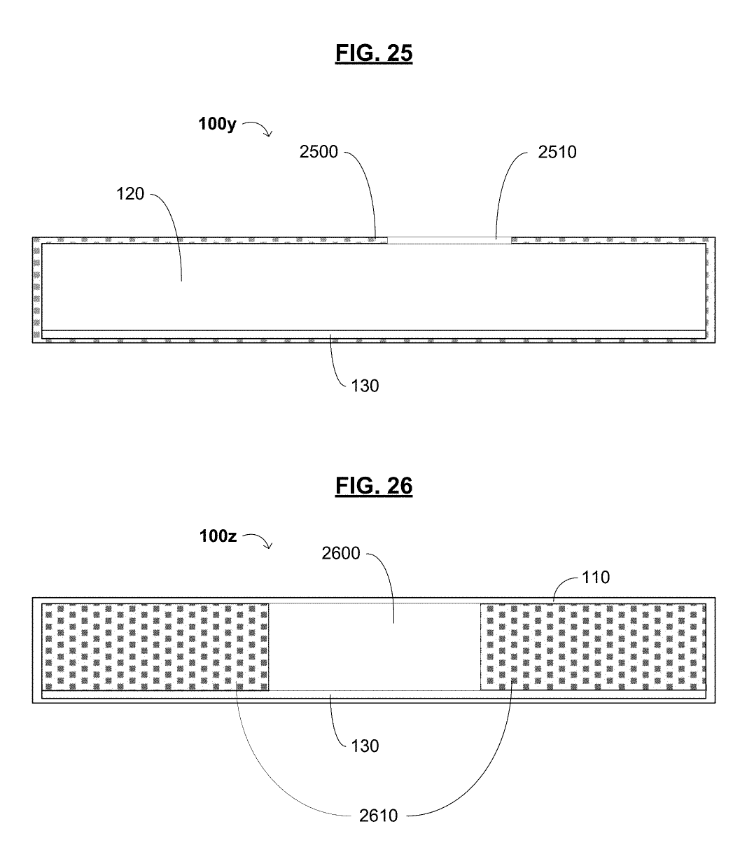

In various embodiments, the pad comprises a material having any of a varying degree of thicknesses, opacities, designs and/or colors above or around the light source to allow more or less light to pass, as shown in FIGS. 25-30. For example, FIG. 25 shows a side view of a changing pad 100y including the cushion 120, the semi-rigid section 130, and an opaque outer material 2500 having a transparent section 2510. The opaque outer material 2500 is configured to block light, and the transparent section 2510 is configured to allow light to pass through.

FIG. 26 shows a side view of a changing pad 100z including the outer material 110, the semi-rigid section 130, and a cushion having one or more opaque sections 2610 and a transparent section 2600. The opaque sections 2610 are configured to block light, and the transparent section 2600 is configured to allow light to pass through.

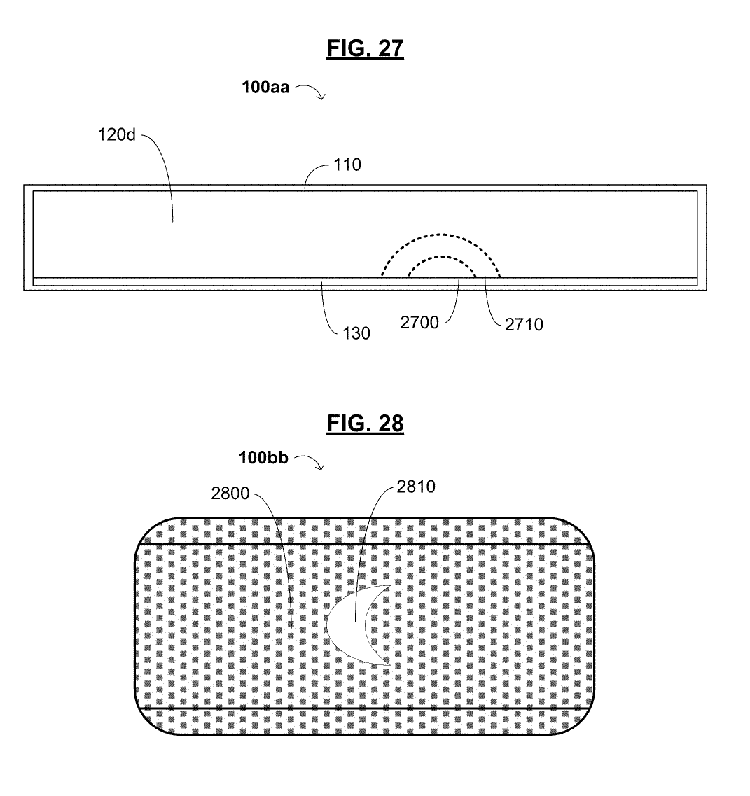

FIG. 27 shows a side view of a changing pad 100aa including the outer material 110, a cushion 120d, and the semi-rigid section 130. Sections 2700 and 2710 are removed from the cushion 120d to make space for a light source or a compartment, respectively. The sections 2700 and 2710 may have shapes including a circle, oval, rectangle, star, moon, or other geometric or aesthetic shape.

FIG. 28 shows a top-down view of a changing pad 100bb with an opaque outer material 2800 having a transparent decorative shape 2810 therein. The opaque outer material 2800 is configured to block light and the transparent decorative shape 2810 is configured to allow light to pass. The transparent decorative shape 2810 may have other shapes including a circle, oval, rectangle, star, moon, or other geometric or aesthetic shape.

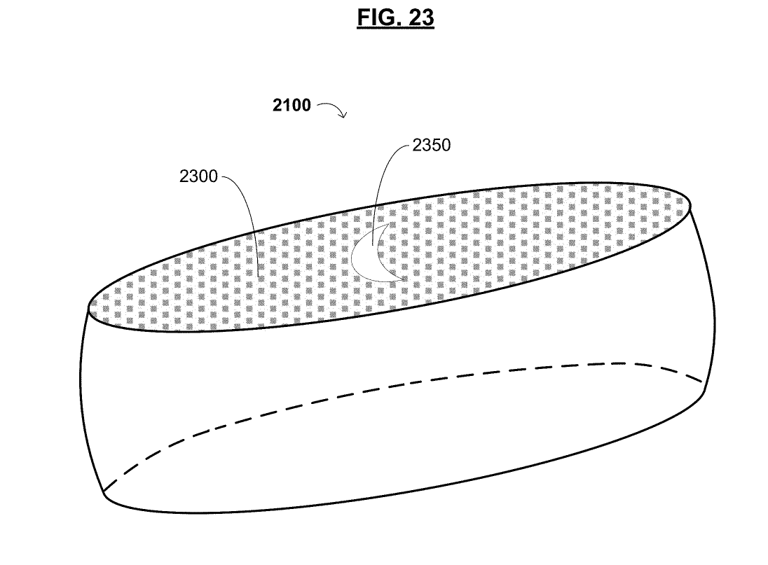

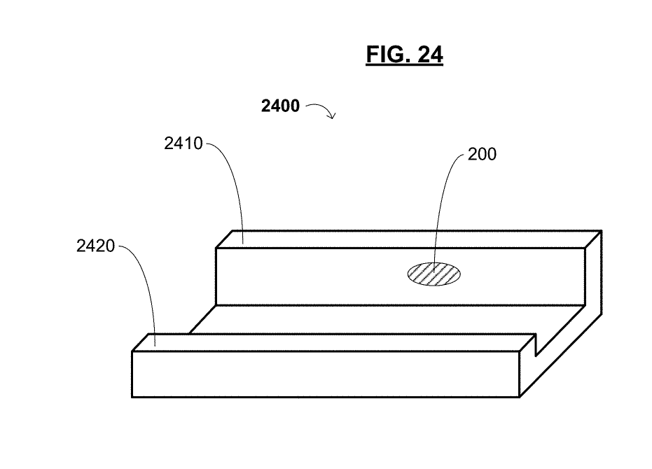

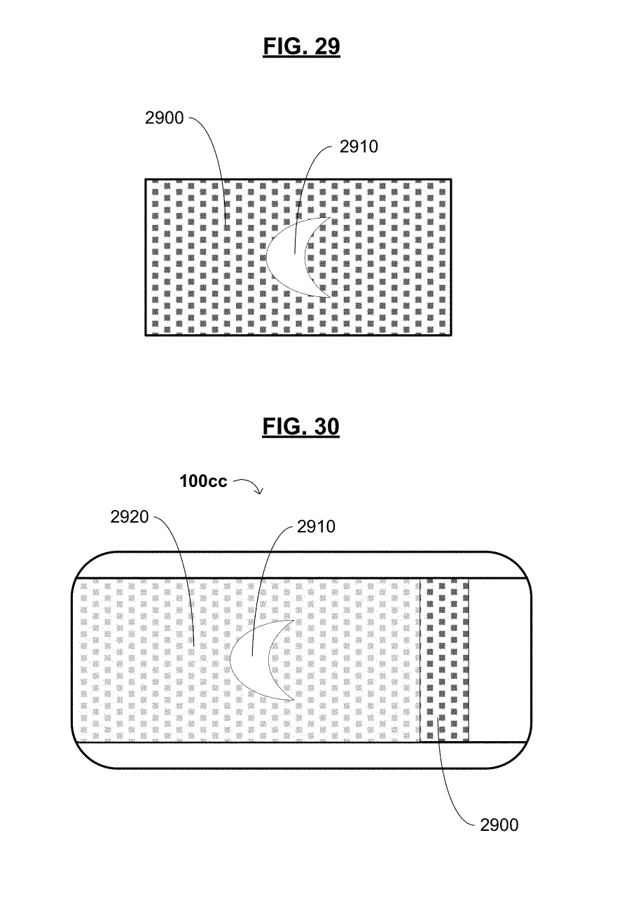

FIG. 29 shows an opaque insertable sheet 2900 with a transparent decorative shape 2910 thereon or therein. The opaque insertable sheet 2900 is configured to block light, and the transparent decorative shape 2910 is configured to allow light to pass through. FIG. 30 shows a top-down view of a changing pad 100cc with a transparent sleeve 2920 in an uppermost surface of the outer cover. The opaque insertable material 2900 is inserted into the sleeve 2920 with the transparent decorative shape 2910 in a predetermined location such that light passing through the shape 2910 irradiates the infant's diaper region. In various embodiments, the cover or sleeve may comprise multiple sections or regions of light diffusing material having varying degrees of opacity, as shown in FIG. 23. FIG. 23 shows a removable mattress pad or sheet-type cover 2100 with an opaque top 2300 that blocks light. A transparent decorative shape 2350 is designed into the opaque top 2300 that allows light to pass through to the diaper-changing area of the infant.

In other embodiments, the pad and the cover may comprise varying degrees of light diffusion material. The pad outer material or the cover may comprise transparent designs such as stars, circles, moons, or logos to direct light near the diaper area. Other portions of the outer material or cover may be more opaque to restrict light, as shown in FIGS. 23 and 25. A light blocking material such as, but not limited to, thick felt or thin plastic, may be placed between the padding and the outer surface, or placed within an integrated pocket or sleeve in the outer material. The light blocking material allows the user to change designs as desired with a shape that allows and restricts light where desired, as shown in FIG. 28. The shape may be a cut-out or a more transparent material, as shown in FIGS. 29 and 30.

It may be understood that all listed concepts may be used independently or in combination with any other aspect described to produce the uniquely desired results. For example, any aspect or embodiment of the present infant diaper changing system may be used in a method of illuminating the diaper changing area of an infant or changing an infant's diaper. It may be further understood that some concepts may be illustrated to various degrees, but that the descriptive text covers and explains in plain language all aspects, whether or not illustrated, due to the conceptual or varying nature of the aspect.

### CONCLUSION

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An infant changing system, comprising:
a pad configured to support an infant during a diaper change,
an illumination device configured to emit light toward or from a first predetermined area of the pad, and
a mechanism configured to secure the illumination device directly or indirectly to the pad, or to direct the light to a second predetermined area of the pad different from the first predetermined area of the pad.

2. The infant changing device of claim 1, wherein the mechanism is configured to secure the illumination device directly or indirectly to the pad.

3. The infant changing system of claim 1, wherein the mechanism comprises a first compartment in the pad configured to hold the illumination device and allow the illumination device to emit said light.

4. The infant changing system of claim 3, further comprising a second compartment configured to house electronics associated with the illumination device.

5. The infant changing system of claim 4, further comprising a quick release mechanism configured to connect and disconnect the first compartment and/or the second compartment from the pad.

6. The infant changing system of claim 4, wherein the first compartment or the second compartment are sealed at one end and have an electrical connector and/or interface to connect the electronics to a power source.

7. The infant changing system of claim 3, wherein the first compartment has a back wall and side walls comprising an opaque material, and a transparent wall facing a surface of the pad contacting the infant to direct the light towards the infant.

8. The infant changing system of claim 1, wherein the pad comprises (i) a cushion having a generally planar surface, and (ii) an outer material.

9. The infant changing system of claim 1, further comprising a cover on or over the pad.

10. The infant changing system of claim 1, further comprising a pressure sensitive switch connected to the illumination device.

11. The infant changing system of claim 1, wherein the light is directed to a center of the surface of the pad contacting the infant, and the illumination device is placed above, below, or within the pad, or within the outer material or the cover.

12. The infant changing system of claim 1, wherein the illumination device comprises a light-emitting diode (LED).

13. The infant changing system of claim 1, further comprising an integrated switch or power connect configured to turn the illumination device on and off.

14. The infant changing system of claim 1, further comprising a controller configured to receive information from a sensor indicating a presence of the infant and turn on the illumination device in response thereto.

15. The infant changing system of claim 1, wherein the pad has an infant contact surface and further comprises a wall extending above the infant contact surface to protect the infant.

16. The infant changing system of claim 1, wherein the pad contains raised sections between the illumination device and the infant's eyes to block light from the infant's eyes.

17. The infant changing system of claim 1, wherein the pad comprises a material that controls light diffusion.

18. The infant changing system of claim 17, wherein the material is polyester, cotton, or wool.

19. The infant changing system of claim 1, wherein the pad further contains a semi-rigid section.

20. The infant changing system of claim 1, wherein the illumination device includes a tapered diffusion section in the pad.

21. A method of illuminating a diaper changing area of an infant, comprising:
setting or placing an infant on a pad configured to support an infant during a diaper change; and
turning on an illumination device secured directly or indirectly to the pad or proximate to a first predetermined area of the pad, the illumination device configured to emit light toward a second predetermined area of the pad.

22. A method of changing a diaper of an infant, comprising:
the method of claim 21; and
changing the diaper of the infant.
